(19) United States
(12) Patent Application Publication
(10) Pub. No.: US 2026/0357759 A1
(43) Pub. Date: Nov. 12, 2026

(54) OUTBOARD MOTOR

(71) Applicant: HONDA MOTOR CO., LTD., Tokyo (JP)

(72) Inventor: Tomohiro MIYAUCHI, Tokyo (JP)

(21) Appl. No.: 19/636,198

(22) Filed: Apr. 1, 2026

(30) Foreign Application Priority Data
May 8, 2025 (JP) 2025-078100

(51) Int. Cl. F02D 31/00; B63H 21/21; F02B 61/04; F02D 9/08

(52) U.S. Cl. CPC F02D 31/009; F02B 61/045; F02D 9/08; B63H 2021/216; F02D 2200/0404; F02D 2200/101

(57) ABSTRACT

An outboard motor includes a throttle sensor, a rotation speed sensor, and an engine controller configured to control an engine, based on a throttle opening degree and an engine rotation speed. The engine controller includes a target output setting unit configured to set a target output of the engine, the target output setting unit sets a final target output that increases in accordance with an accumulated rotation amount of the engine during a period from when a throttle is fully closed to when the engine rotation speed decreases to a predetermined threshold, which is higher than an idling rotation speed, and the engine controller increases an output of the engine to obtain the final target output when the engine rotation speed reaches the threshold.

### INCORPORATION BY REFERENCE

The present application claims priority under 35 U.S.C. § 119 to Japanese Patent Application No. 2025-078100 filed on May 8, 2025. The content of the application is incorporated herein by reference in its entirety.

### BACKGROUND

### Technical Field

The present invention relates to an outboard motor.

### Related Art

There is a known outboard motor including a throttle sensor that detects a throttle opening degree, a rotation speed sensor that detects an engine rotation speed, and an engine controller that controls the engine, based on the throttle opening degree and the engine rotation speed. JP 2023-121356 A discloses a technique, in order to brake a boat, when the shift position is switched between a forward movement and a reverse movement, for determining switching of the shift position to a reverse movement wheel, increasing the output of the engine, based on a boat speed, and preventing engine stop.

### SUMMARY

The technique described in JP 2023-121356 A necessitates detection of switching of the shift position and detection of the boat speed, and it is not possible to use a general-purpose remote controller that does not have a function of detecting switching of the shift position, for example, a remote controller that does not output a reverse signal.

In addition, for a control device of an outboard motor that does not detect the boat speed, it is not possible to determine whether a state in which the throttle is fully closed and the engine rotation speed is high corresponds to a braking mode or a snap mode. Hence, in the conventional control, an increase in air amount is uniformly set when the engine rotation speed becomes lower than a predetermined engine rotation speed. For this reason, in the snap mode, the air amount becomes excessive, and operability may be affected.

In order to solve the above problems, it is an object of the present application to achieve both prevention of engine stop and improvement in operability in various operating situations without necessitating detection of switching of a shift position or detection of a boat speed.

As one aspect of the present disclosure, an outboard motor includes: a throttle sensor configured to detect a throttle opening degree; a rotation speed sensor configured to detect an engine rotation speed; and an engine controller configured to control an engine, based on the throttle opening degree and the engine rotation speed, in which the engine controller includes a target output setting unit configured to set a target output of the engine, the target output setting unit sets a final target output that increases in accordance with an accumulated rotation amount of the engine during a period from when a throttle is fully closed to when the engine rotation speed decreases to a predetermined threshold, which is higher than an idling rotation speed, and the engine controller increases an output of the engine to obtain the final target output when the engine rotation speed reaches the threshold.

According to the present invention, it becomes possible to achieve both prevention of engine stop and improvement in operability in various operating situations without necessitating detection of switching of a shift position or detection of a boat speed.

### BRIEF DESCRIPTION OF DRAWINGS

FIG. 1 is a view illustrating an outboard motor according to a first embodiment;

FIG. 2 is a block diagram illustrating a configuration of an engine control system of the outboard motor;

FIG. 3 is a flowchart illustrating calculation processing of an idle air amount;

FIG. 4 is a diagram illustrating a situation of a braking mode;

FIG. 5 is a diagram illustrating a situation of a snap mode; and

FIG. 6 is a block diagram illustrating an engine control system of the outboard motor according to a second embodiment.

### DETAILED DESCRIPTION

Hereinafter, embodiments of the present invention will be described with reference to the drawings.

### First Embodiment

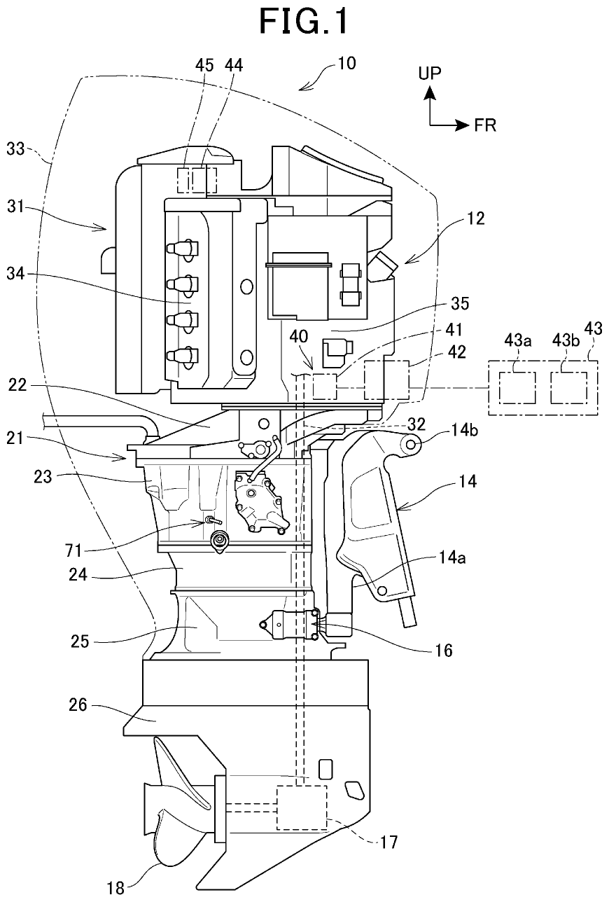

FIG. 1 is a view illustrating an outboard motor 10 according to a first embodiment.

The outboard motor 10 includes: an outboard motor main body 12; an attachment portion 14, which is attached to a boat; and a lower mount portion 16, which elastically supports the outboard motor main body 12 with respect to the attachment portion 14. In FIG. 1, reference sign FR indicates a forward direction of the outboard motor 10, and reference sign UP indicates an upward direction of the outboard motor 10.

The outboard motor main body 12 includes a case (also referred to as a casing) 21, which extends in an up-down direction, and which includes a lower portion immersible under the water surface. The case 21 covers a crankshaft 32, which extends downward from an internal combustion engine 31 (hereinafter, the “engine 31”).

The case 21 includes: a mount case 22; an oil case 23, which is coupled to a lower end surface of the mount case 22; an upper separator 24, which is coupled to a lower end surface of the oil case 23; an extension case 25, which is coupled to a lower end surface of the upper separator 24; and a gear case 26, which is coupled to a lower end surface of the extension case 25.

The attachment portion 14 includes: a swivel shaft 14a, which extends in the up-down direction; and a tilt shaft 14b, which extends in a left-right direction, and which is attached to a stern of the boat. The lower end of the swivel shaft 14a is supported by the extension case 25 via the lower mount portion 16. The engine 31 is supported on an upper end surface of the mount case 22 with the crankshaft 32 vertically disposed.

The engine 31 is disposed at a position higher than the water surface, and is covered with an engine cover 33. In addition, the engine 31 includes a V-type multi-cylinder engine in which a pair of banks 34 include a plurality of cylinders each being disposed in the up-down direction, and are disposed in a letter V shape. Each bank 34 is coupled to a crankcase 35, and the crankshaft 32 is rotatably supported by the crankcase 35.

The crankshaft 32 is rotated by the driving force of the engine 31, and the rotation of the crankshaft 32 is transmitted to a propeller 18 via a clutch mechanism 17. The clutch mechanism 17 is constituted of a so-called dog clutch. In addition, the outboard motor main body 12 includes: a shift mechanism 41, which operates the clutch mechanism 17; and an engine controller 42, which controls the shift mechanism 41. The clutch mechanism 17 and the shift mechanism 41 constitute a shift device 40.

The engine controller 42 includes a processor, a memory, and a peripheral circuit, and functions as a computer that controls each unit of the outboard motor 10 by the processor reading and executing a control program stored in the memory.

The engine controller 42 is connected with an operation device 43, which is provided on the boat. The operation device 43 is also referred to as a remote controller and a remote control device, and is a device that receives an input operation of a user who is a boat operator. In the operation device 43, a shift lever 43a, which adjusts the speed of the boat to switch among a forward movement, neutral, and a reverse movement, is provided.

The operation device 43 in the present embodiment is a general-purpose remote controller that does not have a function of detecting switching of the shift position of the shift lever 43a, and is, for example, a remote controller that does not output a reverse signal.

The engine 31 includes: a throttle device 44, which adjusts an air amount to be supplied to the engine 31; and an air control valve 45, which adjusts the air amount at a low speed including an idle air amount. The air control valve 45 is constituted of an electrically driven type to be driven by a signal from the engine controller 42, that is, an electric air control valve (EACV).

The throttle device 44 is constituted in a mechanical throttle system in which a throttle valve 44a and the operation device 43 are connected with each other by a wire cable.

The air control valve 45 adjusts the air amount to the engine 31 using a bypass passage, but there is no limitation to this. Note that the idle air amount denotes an intake air amount during idling, and will also be referred to as an idle intake air amount, a bypass air amount, or a secondary air amount.

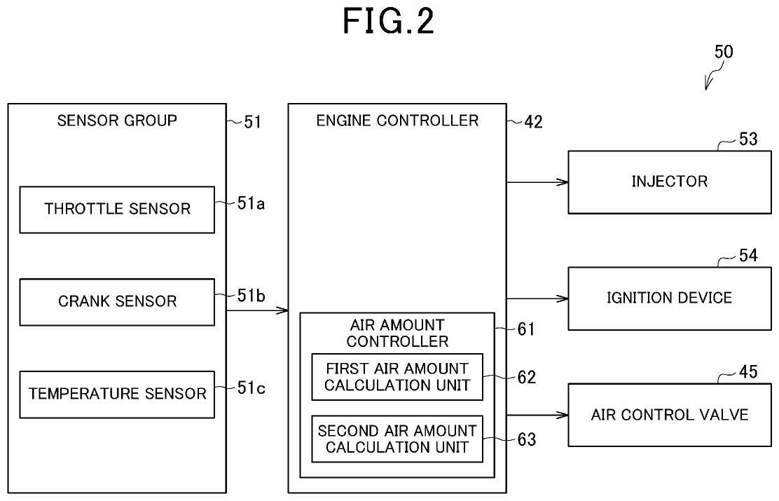

FIG. 2 is a block diagram illustrating a configuration of an engine control system 50 of the outboard motor 10.

As illustrated in FIG. 2, the engine controller 42 controls an injector 53, which supplies the engine 31 with fuel, based on detection results of a sensor group 51, an ignition device 54, which constitutes an ignition system of the engine 31, and the air control valve 45.

In the engine controller 42, an air amount controller 61 is provided. The air amount controller 61 includes: a first air amount calculation unit 62, which calculates an idle air amount; and a second air amount calculation unit 63, which calculates an air amount in a state other than the idle state. The air amount controller 61 is configured with, for example, software processing or a hardware circuit.

The sensor group 51 includes: a throttle sensor 51a, which detects a throttle opening degree corresponding to a throttle operation by the user; a crank sensor 51b, which detects a crank angle of the engine 31; and a temperature sensor 51c, which detects a temperature of the engine 31. The crank sensor 51b also serves as a rotation speed sensor that detects an engine rotation speed NE.

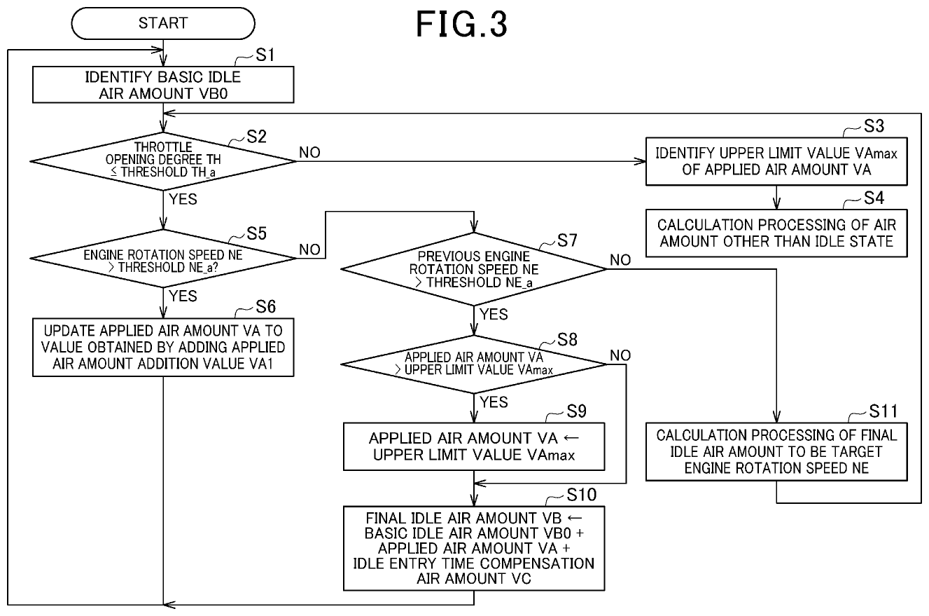

Next, air amount control processing by the engine controller 42 will be described with reference to FIG. 3. FIG. 3 is a flowchart illustrating calculation processing of the idle air amount. This processing is performed in synchronization with a timing when the piston reaches top dead center (TDC), based on a detection result of the crank sensor 51b.

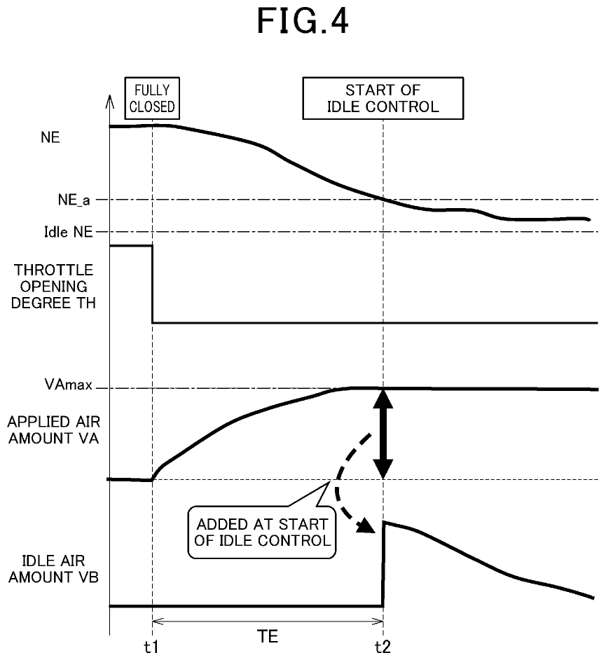

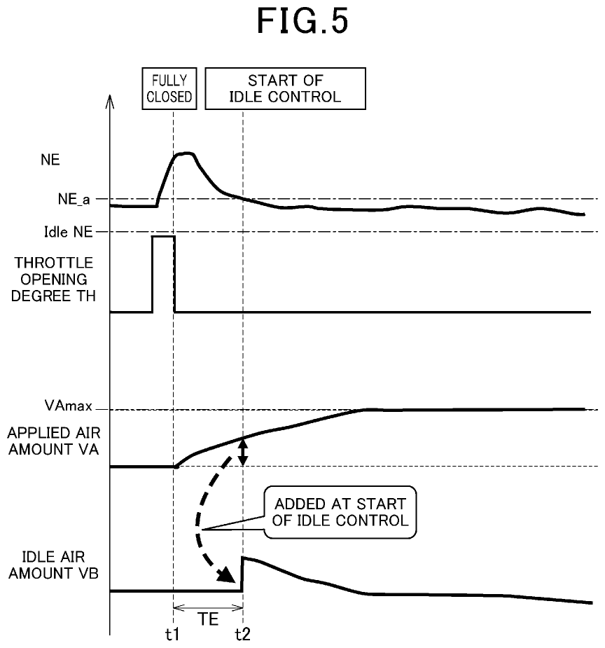

Furthermore, FIGS. 4 and 5 each illustrate an example of a specific situation in which control of the idle air amount is conducted. FIG. 4 illustrates a situation of a braking mode for braking a boat traveling at a middle or high speed, and illustrates a first situation in a case where the user fully closes the throttle opening degree TH at the timing of time t1. In addition, FIG. 5 illustrates a situation of a snap mode in which the user performs a snap accelerator operation for a short period of time in order to finely adjust the engine output when the boat docks traveling at a low speed, and illustrates a second situation in which the throttle opening degree TH is fully closed at the timing of time t1.

The engine controller 42 continuously acquires detection results of the sensor group 51 while performing the air amount control processing, and conducts the air amount control including calculation processing of the idle air amount in accordance with the following procedure.

As illustrated in FIG. 3, the engine controller 42 identifies a basic idle air amount VB0 (step S1), and determines whether the throttle opening degree TH is equal to or smaller than a predetermined threshold TH_a (step S2). In a case where the throttle opening degree TH is larger than the threshold TH_a (step S2: NO), the engine controller 42 causes the first air amount calculation unit 62 to identify an upper limit value VAmax of an applied air amount VA by the air control valve 45 (step S3), and causes the second air amount calculation unit 63 to perform calculation processing of the air amount in a state other than the idle state (step S4).

The threshold TH_a is set to a threshold that identifies a control start timing of the idle air amount. In the present embodiment, the threshold TH_a is set to a value corresponding to a fully closed state of the throttle opening degree TH or falling within a range that can be regarded as the fully closed state.

In addition, the upper limit value VAmax of the applied air amount VA is a preset upper limit value, and is identified, based on, for example, table data in which the engine rotation speed NE and the upper limit value VAmax are associated with each other. This enables the upper limit value VAmax corresponding to the engine rotation speed NE to be easily identified.

Known processing is widely applicable to the calculation processing of the air amount in a state other than the idle state, in step S4.

In a case where the throttle opening degree TH is equal to or smaller than the threshold TH_a (step S2: YES), the engine controller 42 determines whether the engine rotation speed NE is higher than a predetermined threshold NE_a, which is higher than an idling rotation speed (Idle NE in FIGS. 4 and 5) (step S5). In a case where the engine rotation speed NE is higher than the threshold NE_a (step S5: YES), the applied air amount VA is updated to a value obtained by adding an applied air amount addition value VA1 to the applied air amount VA (step S6), and the processing proceeds to step S1. In step S6, for example, it is sufficient to add the applied air amount addition value VA1 to a preset value, and to update with the preset value. It is sufficient to set the preset value to an appropriate value including zero.

The applied air amount addition value VA1 is identified, based on, for example, table data in which the engine rotation speed NE after the throttle is fully closed and the applied air amount addition value VA1 are associated with each other. This enables the applied air amount addition value VA1 corresponding to the engine rotation speed NE to be easily identified.

In a case where the engine rotation speed NE is equal to or lower than the threshold NE_a (step S5: NO), the engine controller 42 determines whether the previous engine rotation speed NE was higher than the threshold NE_a (step S7). In a case where the previous engine rotation speed NE was higher than the threshold NE_a (step S7: YES), and in a case where the applied air amount VA is larger than the upper limit value VAmax (step S8: YES), the engine controller 42 sets the applied air amount VA to the upper limit value VAmax (step S9), and proceeds to a process of step S10.

On the other hand, in a case where the applied air amount VA is equal to or smaller than the upper limit value VAmax (step S8: NO), the engine controller 42 proceeds to the process of step S10.

In step S10, the engine controller 42 causes the first air amount calculation unit 62 to calculate a final idle air amount VB. In this case, the applied air amount VA calculated in step S5 and an idle entry time compensation air amount VC are added to the basic idle air amount VB0, and an addition result is set to the final idle air amount VB. After the process of step S10, the processing proceeds to the process of step S1.

The basic idle air amount VB0 denotes an air amount corresponding to a target engine rotation speed NE, and is identified, based on, for example, table data in which the target engine rotation speed NE and the basic idle air amount VB0 are associated with each other.

When the engine rotation speed NE reaches the threshold NE_a, the engine controller 42 controls the air control valve 45 to obtain the final idle air amount VB that has been set, and then conducts PID control on the engine 31 to converge into the idling rotation speed.

In a case where the previous engine rotation speed NE was equal to or lower than the threshold NE_a in step S7 (step S7: NO), the engine controller 42 adjusts the final idle air amount VB to obtain the target engine rotation speed NE (step S11), and then proceeds to the process of step S1.

In this manner, the engine controller 42 calculates the final idle air amount VB, based on the detection results of the sensor group 51, and controls the air control valve 45 to control the engine 31 of the outboard motor 10. In particular, when the engine rotation speed NE reaches the threshold NE_a, the stable operation of the engine 31 is ensured by appropriately setting the final idle air amount VB.

According to this engine control, in each situation illustrated in FIGS. 4 and 5, from time t1 when the throttle opening degree TH becomes fully closed, whenever the piston reaches the top dead center, the applied air amount VA becomes a value obtained by accumulating the applied air amount addition value VA1. Then, at time t2 when the idle control is started, that is, when the engine rotation speed NE reaches the threshold NE_a, the air control valve 45 is controlled to obtain the final idle air amount VB, which is obtained by adding the applied air amount VA.

Thus, as an elapsed time TE from time t1 to time t2 is longer, an increase amount of the final idle air amount VB increases, and the engine rotation speed NE increases.

In the situation of the braking mode illustrated in FIG. 4, the elapsed time TE is long. Thus, the applied air amount VA becomes the upper limit value VAmax or a value close to the upper limit value VAmax, and the decrease in the engine rotation speed NE from time t2 becomes slow.

This situation corresponds to while braking the boat, and there is a high possibility that after the throttle opening degree TH is fully closed, a period of time elapses, and then the user performs an operation of switching the shift position from the forward movement to the reverse movement. Since the decrease in the engine rotation speed NE from time t2 is slow, it becomes possible to prevent the engine 31 from stopping even though the shift position is switched. Therefore, it becomes possible to prevent the engine from stopping at the time of shifting without detecting the switching of the shift position and without detecting the boat speed.

In the situation of the snap mode illustrated in FIG. 5, the elapsed time TE is short. Thus, the applied air amount VA does not reach the upper limit value VAmax at time t2, and the final idle air amount VB is controlled to be small. Thus, it becomes possible to promptly decrease the engine rotation speed NE from time t2, and a so-called rotation reduction of the engine 31 is accelerated.

In this situation, there is a high possibility that a snap accelerator operation is performed. In such a case, since it is possible to promptly decrease the engine rotation speed NE, the responsiveness of the snap accelerator operation is improved. Therefore, it becomes possible to avoid a situation in which the responsiveness of the operation decreases, or the shift operation becomes heavy, because the engine rotation speed NE does not decrease promptly.

As described heretofore, the outboard motor 10 in the present embodiment includes the engine controller 42, which controls the engine 31, based on the throttle opening degree TH and the engine rotation speed NE. The engine controller 42 includes the first air amount calculation unit 62, which functions as a target output setting unit that sets a target output of the engine 31. The first air amount calculation unit 62 sets the final idle air amount VB, which increases in accordance with an accumulated rotation amount of the engine 31 during a period from when the throttle is fully closed to when the engine rotation speed NE decreases to the predetermined threshold NE_a, which is higher than the idling rotation speed. Then, when the engine rotation speed NE reaches the threshold NE_a, the engine controller 42 controls the air control valve 45 to obtain the final idle air amount VB.

The final idle air amount VB is an example of the “final target output” in the present disclosure, and controlling from the applied air amount VA as a target output increase amount to the final idle air amount VB to be calculated corresponds to an example of “increasing the output of the engine 31” in the present disclosure. In addition, the “accumulated rotation amount of the engine 31 during the period from when the throttle is fully closed to when the engine rotation speed decreases to the predetermined threshold NE_a, which is higher than the idling rotation speed” in the present disclosure denotes, for example, counting the number of times the piston passes through the top dead center as the accumulated rotation amount.

According to this configuration, when the throttle is fully closed from a middle- or high-speed rotation range, the target output becomes high. Thus, it becomes possible to prevent the engine from stopping at the time of shifting to the reverse movement or the like without detecting the shift position or the boat speed. Further, when the throttle is fully closed in a low-rotation range, it becomes possible to promptly decrease the engine rotation speed, and the responsiveness of the shift operation and the snap accelerator is improved. Therefore, it becomes possible to achieve both prevention of the engine stop and improvement in the operability in various operating situations without necessitating detection of switching of the shift position or detection of the boat speed.

In addition, the first air amount calculation unit 62 identifies the applied air amount addition value VA1 as a first target output increase coefficient that differs depending on the engine rotation speed NE when the throttle is fully closed, adds the identified applied air amount addition value VA1 in accordance with the accumulated rotation amount, and determines the applied air amount VA as the target output increase amount. The target output increase amount corresponds to an increase amount of the final idle air amount VB. According to this configuration, by reflecting the engine rotation speed NE when the throttle is fully closed, an appropriate target output can be set regardless of the boat speed or the like.

In addition, in a case where the applied air amount VA as the target output increase amount that increases in accordance with the accumulated rotation amount exceeds the preset upper limit value VAmax, the first air amount calculation unit 62 sets the upper limit value VAmax to the applied air amount VA. According to this configuration, it becomes possible to avoid a situation in which the target output is excessively high. Further, by setting the upper limit value VAmax in accordance with the engine rotation speed NE, an appropriate target output can be set regardless of the boat speed or the like.

In addition, after the engine rotation speed NE reaches the final idle air amount VB as the final target output, the engine controller 42 controls the engine rotation speed NE to converge into the idling rotation speed. This makes the behavior of the engine rotation speed NE stable.

Further, the outboard motor 10 has a configuration including the air control valve 45, which is capable of adjusting the intake air amount to the engine 31, and control to obtain the final target output is conducted by increasing the opening degree of the air control valve 45. Accordingly, by utilizing the air control valve 45, it becomes possible to achieve both prevention of the engine stop and improvement in the operability.

### Second Embodiment

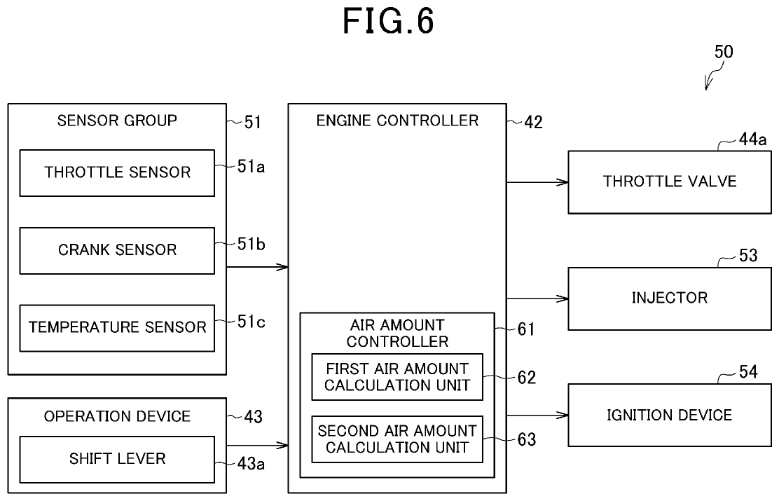

FIG. 6 is a block diagram illustrating an engine control system 50 of the outboard motor 10 according to a second embodiment. In the present description, the same components as those in the first embodiment are denoted by the same reference numerals, and overlapping description will be omitted.

The outboard motor 10 in the second embodiment employs an electric throttle system in which the throttle valve 44a is driven by a motor, and has a configuration in which the air control valve 45 is not included. The engine controller 42 controls the throttle valve 44a, the injector 53, the ignition device 54, and the like, based on detection results of the sensor group 51.

By controlling the opening degree of the throttle valve 44a, the engine controller 42 controls the idle air amount. Thus, the control to obtain the final idle air amount VB that has been set by the first air amount calculation unit 62 is also conducted by increasing the opening degree of the throttle valve 44a using the motor. Therefore, even in a configuration that does not include the air control valve 45, it becomes possible to achieve both prevention of the engine stop and improvement in the operability by adjusting the opening degree of the throttle valve 44a.

### Other Embodiments

The above embodiments are merely aspects of the present invention, and can be optionally modified, improved, and applied without departing from the gist of the present invention.

### Configurations Supported by Above Embodiments

The above embodiments support the following configurations.

(Configuration 1) An outboard motor includes: a throttle sensor configured to detect a throttle opening degree; a rotation speed sensor configured to detect an engine rotation speed; and an engine controller configured to control an engine, based on the throttle opening degree and the engine rotation speed, in which the engine controller includes a target output setting unit configured to set a target output of the engine, the target output setting unit sets a final target output that increases in accordance with an accumulated rotation amount of the engine during a period from when a throttle is fully closed to when the engine rotation speed decreases to a predetermined threshold, which is higher than an idling rotation speed, and the engine controller increases an output of the engine to obtain the final target output when the engine rotation speed reaches the threshold.

According to this configuration, when the throttle is fully closed from a middle- or high-speed rotation range, the target output becomes high. Thus, it becomes possible to prevent the engine from stopping at the time of shifting to the reverse movement or the like without detecting the shift position or the boat speed. Further, when the throttle is fully closed in a low-rotation range, it becomes possible to promptly decrease the engine rotation speed, and the responsiveness of the shift operation and the snap accelerator is improved. Therefore, it becomes possible to achieve both prevention of the engine stop and improvement in the operability in various operating situations without necessitating detection of switching of the shift position or detection of the boat speed.

(Configuration 2) The outboard motor according to the configuration 1, in which the target output setting unit identifies a first target output increase coefficient that differs depending on an engine rotation speed after the throttle is fully closed, adds the first target output increase coefficient that has been identified in accordance with the accumulated rotation amount, and determines a target output increase amount corresponding to an increase amount of the final target output.

According to this configuration, by reflecting the engine rotation speed when the throttle is fully closed, it becomes possible to set an appropriate target output regardless of the boat speed or the like.

(Configuration 3) The outboard motor according to the configuration 2, in which in a case where the target output increase amount that increases in accordance with the accumulated rotation amount is larger than a preset upper limit value, the target output setting unit sets the upper limit value to the target output increase amount.

According to this configuration, it becomes possible to avoid a situation in which the target output is excessively high. Further, by setting the upper limit value in accordance with the engine rotation speed when the throttle is fully closed, an appropriate target output can be set regardless of the boat speed or the like.

(Configuration 4) The outboard motor according to one of the configurations 1 to 3, in which after the engine rotation speed reaches the final target output, the engine controller controls the engine rotation speed to converge into the idling rotation speed.

According to this configuration, the behavior of the engine rotation speed is made stable.

(Configuration 5) The outboard motor according to one of the configurations 1 to 4, further includes an air control valve capable of adjusting an intake air amount to the engine, in which control to obtain the final target output is conducted by increasing an opening degree of the air control valve.

According to this configuration, by utilizing the air control valve, it becomes possible to achieve both prevention of the engine stop and improvement in the operability.

(Configuration 6) The outboard motor according to one of the configurations 1 to 4, further includes a configuration in which a throttle valve configured to adjust the throttle opening degree is driven by a motor, in which control to obtain the final target output is conducted by increasing an opening degree of the throttle valve using the motor.

According to this configuration, even in a configuration that does not include the air control valve, it becomes possible to achieve both prevention of the engine stop and improvement in the operability by adjusting the opening degree of the throttle valve.

### REFERENCE SIGNS LIST

10 Outboard motor
31 Engine
41 Shift mechanism
42 Engine controller
43 Operation device (remote controller)
44 Throttle device
44a Throttle valve
45 Air control valve
50 Engine control system
51 Sensor group
51a Throttle sensor
51b Crank sensor (rotation speed sensor)
51c Temperature sensor
62 First air amount calculation unit (target output setting unit)
VA Applied air amount addition value (target output increase amount)
VB Final idle air amount (final target output)
VA1 Applied air amount addition value (first target output increase coefficient)
NE_a Predetermined threshold
VAmax Upper limit value

What is claimed is:

1. An outboard motor comprising:
a throttle sensor configured to detect a throttle opening degree;
a rotation speed sensor configured to detect an engine rotation speed; and
an engine controller configured to control an engine, based on the throttle opening degree and the engine rotation speed, wherein
the engine controller includes a target output setting unit configured to set a target output of the engine,
the target output setting unit sets a final target output that increases in accordance with an accumulated rotation amount of the engine during a period from when a throttle is fully closed to when the engine rotation speed decreases to a predetermined threshold, which is higher than an idling rotation speed, and
the engine controller increases an output of the engine to obtain the final target output when the engine rotation speed reaches the threshold.

2. The outboard motor according to claim 1, wherein
the target output setting unit identifies a first target output increase coefficient that differs depending on an engine rotation speed after the throttle is fully closed, adds the first target output increase coefficient that has been identified in accordance with the accumulated rotation amount, and determines a target output increase amount corresponding to an increase amount of the final target output.

3. The outboard motor according to claim 2, wherein
in a case where the target output increase amount that increases in accordance with the accumulated rotation amount is larger than a preset upper limit value, the target output setting unit sets the upper limit value to the target output increase amount.

4. The outboard motor according to claim 1, wherein
after the engine rotation speed reaches the final target output, the engine controller controls the engine rotation speed to converge into the idling rotation speed.

5. The outboard motor according to claim 1, further comprising
an air control valve capable of adjusting an intake air amount to the engine, wherein
control to obtain the final target output is conducted by increasing an opening degree of the air control valve.

6. The outboard motor according to claim 1, further comprising
a configuration in which a throttle valve configured to adjust the throttle opening degree is driven by a motor, wherein
control to obtain the final target output is conducted by increasing an opening degree of the throttle valve using the motor.
